(19) United States
(12) Patent Application Publication
(10) Pub. No.: US 2019/0367331 A1
(43) Pub. Date: Dec. 5, 2019

(54) ELEVATOR SYSTEM COMPRISING AT LEAST TWO ELEVATOR CARS THAT CAN TRAVEL ALONG A COMMON RAIL SECTION

(71) Applicants: THYSSENKRUPP ELEVATOR AG, Essen (DE); thyssenkrupp AG, Essen (DE)

(72) Inventors: Ronald DIETZE, Jettingen (DE); Petros BURUTJIS, Lichtenstein/Unterhausen (DE); Thomas KUCZERA, Leinfelden-Echterdingen (DE); Martin MADERA, Neuhausen (DE)

(73) Assignees: thyssenkrupp Elevator AG, Essen (DE); thyssenkrupp AG, Essen (DE)

(21) Appl. No.: 16/485,223

(22) PCT Filed: Jan. 16, 2018
(86) PCT No.: PCT/EP2018/051010

§ 371 Date: Aug. 12, 2019

(30) Foreign Application Priority Data
Feb. 10, 2017 (DE) 10 2017 202 129.2

(51) Int. Cl. B66B 9/00; B66B 1/28; B66B 7/02; B66B 1/36; B66B 11/04; B66B 1/34

(52) U.S. Cl. CPC B66B 9/003; B66B 1/28; B66B 1/3476; B66B 1/36; B66B 11/0407; B66B 7/023

(57) ABSTRACT

An elevator system may include at least two elevator cars that are movable along a common rail section on a wall. The common rail section may comprise a plurality of rail segments arranged consecutively along a direction of travel of the elevator cars. Furthermore, the rail section may comprise at least one first rotary segment. A first rail segment of the plurality of rail segments may be arranged adjacent to the first rotary segment. The first rail segment may be fixed to the wall via a first fixed bearing such that the first rail segment is fixed in all three directions in space with respect to the wall. The first fixed bearing may be positioned at an end of the first rail segment that faces the first rotary segment.

The invention relates to an elevator system comprising at least two elevator cars which are movable along a common rail section on a wall. Rail sections traditionally extend vertically in a building. However, horizontal rail sections have occasionally also already been proposed. The rail sections are typically assembled from individual rail segments during installation because of large heights of buildings.

During the installation of the rail segments in vertical elevator shafts, it has become accepted to stack the rail segments on one another and to fix them to the shaft wall only in the horizontal direction. This has the advantage that the rail segments are in an abutting relationship along the vertical direction of travel and at the same time an expansion of the rail segments in the vertical direction is permitted in the event of temperature fluctuations. The assembled rail section therefore behaves in the manner of a continuous rail section.

A new type of elevator system, as described, for example, in WO2012/045606, uses a linear motor for driving the elevator cars along the rail section. In this case, a primary part of the linear motor is attached to the rail segments and a secondary part of the linear motor is attached to the elevator car to be moved. This type of drive makes it possible to move a plurality of elevator cars simultaneously along a common rail section independently of one another.

However, this also gives rise to significant technical problems for the rail segments. Firstly, the rail segments are provided with the primary part of the linear motor. This additional weight force has to be absorbed by guide rails. Secondly, in the case of this type of elevator, there are no ropes and counterweights, and therefore all of the vertical forces which act on the elevator car (weight force of the elevator car, acceleration forces of the elevator car, braking forces) have to be absorbed by the rail segments. Since, in addition, a multiplicity of cars operate in the same shaft, this amount is also multiplied.

Due to said increased load, the concept of stacked rail segments is no longer practical since the lowermost rail segments cannot absorb the load of the rail segments located thereabove. Consequently, the rail segments have to be connected individually to the shaft wall.

However, the driving concept of the linear motor leads to a further problem. As also in the case of other electric motors, the primary part, inter alia, heats up during operation. Since the primary part is attached to the rail segments, the heat is dissipated to the rail segments, thus resulting in a significantly greater thermal expansion. In order to take this into considerations adjacent rail segments have to have a distance from one another (also referred to as an expansion joint).

Furthermore, in new buildings, building settlement also occurs. Rail segments which are attached to the wall therefore have to have a distance from one another, the distances providing said settlement. The gap width between adjacent rail segments is reduced by the settlement.

These problems are known from WO 2016/113434. WO 2016/113434 furthermore discloses how the transition between adjacent rail segments can be configured in order to permit problem-free rolling of guide rollers in the region of said transition.

The use of a linear motor for driving the elevator cars along the rail section has the further advantage that a simple change of elevator cars between parallel rail sections is made possible. It is known from JP H06-48672 A to use rail sections with rotary segments for this purpose. This is also disclosed in WO 2015/144781 which explains the transfer method between parallel rail sections in detail. The rotary segments are likewise fastened to the wall. The above-described thermal expansion of the rail segments leads to the distance between the rotary segment and the adjacent rail segment changing. This can lead to the rotatability of the rotary segment being impaired.

It is the object of the invention to provide an elevator system with rotary elements, in which the rotatability of the rotary segments is always ensured.

This object is achieved by an elevator system comprising at least two elevator cars which are movable along a common rail section on a wall. The common rail section here comprises a plurality of rail segments which are arranged consecutively along a direction of travel. Furthermore, the rail section comprises at least one first rotary segment. A first rail segment of the plurality of rail segments is arranged adjacent to the first rotary segment. Said first rail segment is fixed to the wall via a first fixed bearing, i.e. is fixed in all three directions in space with respect to the wall. In this case, the first fixed bearing is arranged at that end of the first rail segment which faces the first rotary segment. The first fixed bearing can act here either directly between the first rail segment and the wall or indirectly via a further holding component. The holding component can be, for example, a support of the first rotary segment. In this case, the support of the first rotary segment is fixed to the wall. Furthermore, the first rail segment is connected at its end to the support. The support is therefore part of the first fixed bearing via which the first rail segment is fixed to the wall. The further fixed bearings which are arranged on rail segments adjacent to rotary segments can also be designed in a corresponding manner.

The fixing by means of fixed bearings ensures that the distance between the first rotary segment and the adjacent first rail segment is fixed and only minimally changes due to thermal expansion. It is thereby ensured that there is a well defined gap between the first rotary segment and the adjacent first rail segment. Too narrow a gap would lead to the first rotary segment no longer being able to rotate. On the other hand, too large a gap would lead to the guide rollers of the elevator cars no longer rolling in a well defined manner when traveling over the gap. In particular, formation of noise and/or vibrations could occur when the guide rollers roll over too large a gap. This would reduce the travel comfort and would also lead to greater wear of the guide rollers. Furthermore, the elevator car is typically braked with the aid of a shoe brake, in which brake shoes are brought into contact with the rail segments for braking purposes. In order not to impair the braking action, there should for this reason only be a small gap between adjacent rail segments and between rail segments and rotary segments. Consequently, the width of the gap has to remain virtually constant during operation of the elevator system. This is achieved by the fact that the first rail segment which is adjacent to the first rotary segment is fixed to the wall via a first fixed bearing, wherein the fixed bearing is arranged at that end of the first rail segment which faces the first rotary segment.

Within the context of this application, a fixed bearing is arranged at the end of a rail segment when the distance, as measured in the direction of travel, between the fixed point of the fixed bearing and the end of the rail segment changes by less than 0.1 mm in the event of a change in temperature of 50 kelvin.

The first fixed bearing therefore forms a fixed point for the first rail segment. Since the first rotary segment is likewise fastened fixedly to the wall, the distance between the first rotary segment and the first fixed bearing remains constant. Owing to the fact that the first fixed bearing is arranged at the facing end of the first rail segment, an excessive thermal expansion of the rail portion lying between the first fixed bearing and the closest rotary segment does not occur. The width of the gap therefore varies by less than 0.2 mm in the event of a change in temperature of 50 K.

While thermal expansions lead to the length of the rail segments changing between bearings, concrete movements typically lead to the distance between the bearing points on the building changing. For example, bearing points move toward one another over time due to building settlement. The configuration according to the invention of the rail sections also takes said concrete movements into account.

Advantageous developments emerge from the dependent claims, the description below and the drawings.

In a development of the invention, a second rail segment of the plurality of rail segments is arranged adjacent to the first rail segment. The second rail segment is fixed here to the wall via a second fixed bearing. The first rail segment is at a distance from the second rail segment, and therefore the first rail segment can thermally expand in the direction of the second rail segment. While the one end of the first rail segment that is arranged adjacent to the first rotary segment is therefore fixed with respect to the wall, the opposite end of the first rail segment can expand in the direction of the second rail segment. Thermal stresses in the first rail segment are thereby avoided.

The first rail segment therefore in particular has precisely one fixed bearing with which the first rail segment is fixed to the wall. Alternatively, the first rail segment is fixed to the wall with a plurality of fixed bearings, wherein the fixed points of the fixed bearings are at a maximum distance from one another. The maximum distance is selected here in such a manner that the thermal expansion of the first rail segment between the fixed points of the bearings is smaller than 0.05 mm in the event of a change in temperature of 50 K.

The second fixed bearing is arranged in particular at that end of the second rail segment which faces away from the first rail segment. The first rail segment and the second rail segment can therefore thermally expand toward each other. Thermal stresses are thereby also avoided in the second rail segment.

In a developed embodiment, the rail section comprises a second rotary segment. In this case, the second rail segment is arranged adjacent to the second rotary segment. Furthermore, the first rail segment and the second rail segment are arranged between the first rotary segment and the second rotary segment. In addition, the second fixed bearing is arranged at that end of the second rail segment which faces the second rotary segment. This development has the advantage that the rotatability of the second rotary segment is also reliably ensured by a well defined gap width being reliably ensured between the second rotary segment and the second rail segment.

In a further variant, the first rail segment and/or the second rail segment are/is fastened by means of at least one movable bearing. The movable bearing fixes the particular rail segment only perpendicularly to the direction of travel and permits free displacement in the direction of travel, i.e. in the main direction of extent of the particular rail segment. The fastening of the particular rail segment is therefore improved without the aforementioned advantages according to the invention being impaired.

In a specific variant embodiment of the invention, the first rail segment and/or the second rail segment comprise/comprises a plurality of rail elements which are arranged one behind another along a direction of travel. This permits simpler transport to the installation site of the elevator system since the individual components are smaller. The individual rail elements of a rail segment are then fixedly connected to one another in the installed state. The rail segment is therefore subject as a whole to thermal expansion.

In a further embodiment of the invention, the elevator cars each comprise at least one braking device. The braking device here acts on that particular rail segment of the plurality of rail segments with which the corresponding elevator car is in engagement when the braking device is activated. This leads to the acceleration force occurring during the braking of the corresponding elevator car being introduced into the particular rail segment.

Alternatively or additionally, the elevator system has a linear drive for driving the elevator cars. The linear drive here comprises a plurality of primary parts which are connected to the rail segments. Furthermore, the linear drive comprises a plurality of secondary parts, wherein each secondary part is connected to one elevator car each. The acceleration force occurring during the acceleration or braking of an elevator car by means of the linear drive therefore acts on that particular rail segment of the plurality of rail segments with which the corresponding elevator car is in engagement during the accelerating or braking. During the accelerating or braking of an elevator car by means of the linear drive, a force acts on the elevator car. The corresponding counterforce (acceleration force) then acts on the rail segment with which the elevator car is in engagement at this time. The acceleration force acts initially on the primary part of the linear drive, said primary part being connected to the rail segment. The force is transmitted from the primary part to the rail segment and is introduced from there into the wall via the first fixed bearing.

In particular, the elevator cars are additionally in engagement with the rail segments in such a manner that the weight force of each elevator car acts via the linear drive or the braking device on that particular rail segment of the plurality of rail segments with which the corresponding elevator car is in engagement. In addition to the previously described acceleration forces by means of the braking and accelerating, the weight force of the elevator car is therefore also absorbed by the rail segment with which the elevator car is in engagement at the particular time.

In a further embodiment of the invention, the elevator system comprises a control system for controlling the movement of the at least two elevator cars. The control system here is designed to control the elevator cars in such a manner that the sum which acts on one rail segment, of the maximum forces of all of the elevator cars which are simultaneously in engagement with the same rail segment of the plurality of rail segments is smaller than a predetermined threshold value.

Within the meaning of this application, the maximum force at a time t is defined as the maximum of the force actually introduced at this time into the rail segment by an elevator car and the force introduced at this time during an emergency stop.

The control system therefore defines the travel curves of all of the elevator cars in such a manner that the forces acting on any desired rail segment are smaller in sum than a predetermined threshold value. Not only are the forces which occur during normal travel along the travel curve taken into consideration here. In addition, for each point of each travel curve, it is also determined which forces would occur if the corresponding elevator car were to carry out an emergency stop at this point of the travel curve. The maximum of said two forces is defined as the maximum force. Therefore, not only is the actually occurring force taken into consideration, but so too is the force present in the event of an emergency. Such a definition of the travel curves of all of the elevator cars, in which the sum of the maximum forces of all of the travel cars (at each time) is smaller than a predetermined threshold value, ensures that only a limited force is introduced into the rail segment in any emergency situation. This has the advantage that the load of the fixed bearing, with which the rail segment is fixed to the wall, can never be exceeded. The safety of the passengers in the elevator cars is thereby ensured.

The invention furthermore relates to an elevator system comprising at least two travel cars which are movable along a common rail section, wherein the common rail section comprises a plurality of rail segments which are arranged consecutively along a direction of travel. Furthermore, the elevator system comprises a control system for activating the movement of the at least two elevator cars. The control system is designed to control the elevator cars in such a manner that the sum, acting on one rail segment, of the maximum forces of all of the elevator cars which are simultaneously in engagement with the same rail segment of the plurality of rail segments, is (at each time) smaller than a predetermined threshold value. As explained above, this has the advantage that only a limited force is introduced into a rail segment in any emergency situation. This has the advantage that the load of the fixed bearings, with which the rail segment is fixed to the wall, can never be exceeded. This advantage is independent of the presence of rotary segments and independent of the number and the position of the fixed bearings per rail segment. It is also advantageous, for example, in the case of rail segments which are fastened with a plurality of fixed bearings, if the control system is designed to control the elevator cars in such a manner that the sum, acting on a rail segment, of the maximum forces of all of the elevator cars which are simultaneously in engagement with said rail segment is smaller than a predetermined threshold value. In order to ensure the safety of the passengers, it is also required in these embodiments for none of the bearings with which the rail segment is fixed to the wall to be overloaded.

In a development of the elevator system according to the invention, the latter comprises at least one sensor for determining the loading of the elevator cars. Furthermore, the control system is designed to determine the maximum forces of all of the elevator cars with the aid of a sensor signal of said sensor. The loading and therefore the current weight force of the elevator cars can thereby be taken into consideration in the calculation of the maximum forces. This leads to a particularly efficient use of the rail section because a plurality of elevator cars can move closely to one another.

Alternatively, the control system is designed in such a manner that the maximally permissible loading is used for the determination of the weight forces and of the maximum forces of all of the elevator cars. The maximum forces are therefore determined under the assumption that all of the elevator cars have their maximum permissible loading. It is thereby ensured that none of the bearings with which the rail segment is fixed to the wall is overloaded, even if all of the elevator cars are fully loaded. The elevator cars are therefore controlled with a higher safety margin. In comparison to taking the actual weight force into consideration by means of the sensor, the rail section is therefore not optimally efficiently used. However, greater safety is ensured by said embodiment since an erroneous sensor signal cannot lead to a wrong calculation of the maximum forces.

In a developed variant of the invention, the predetermined threshold value is 2%, in particular 5%, particularly preferably 10%, lower than the maximally permissible load of the fixed bearing of said rail element, that is to say of the fixed bearings with which said rail segment is fixed to the wall. This ensures that there is a sufficient safety margin, and therefore manufacturing tolerances of the fixed bearing cannot lead to unsafe operation of the elevator system.

In a specific refinement of the elevator system according to the invention, the control system is designed to control the elevator cars in such a manner that, during normal operation of the elevator system, each rail segment is always only traveled along by precisely one elevator car. It can thereby be particularly simply ensured that the sum of the maximum forces of all of the elevator cars which are simultaneously in engagement with the same rail segment of the plurality of rail segments is smaller than a predetermined threshold value. In this case, only precisely one elevator car is in engagement with each rail segment. The maximum force of said elevator car can thereby be determined in a simple manner. In particular, the threshold value in this case is predetermined in such a manner that the maximum force at the maximally permissible loading of the precisely one elevator car and any desired activatable controllable travel curve is smaller (at each time) than the threshold value. The control system is therefore designed in such a manner that a travel situation in which a bearing is overloaded cannot be activated. This increases the safety of the elevator system.

The invention is explained in more detail below with reference to the figures, in which, in each case schematically,

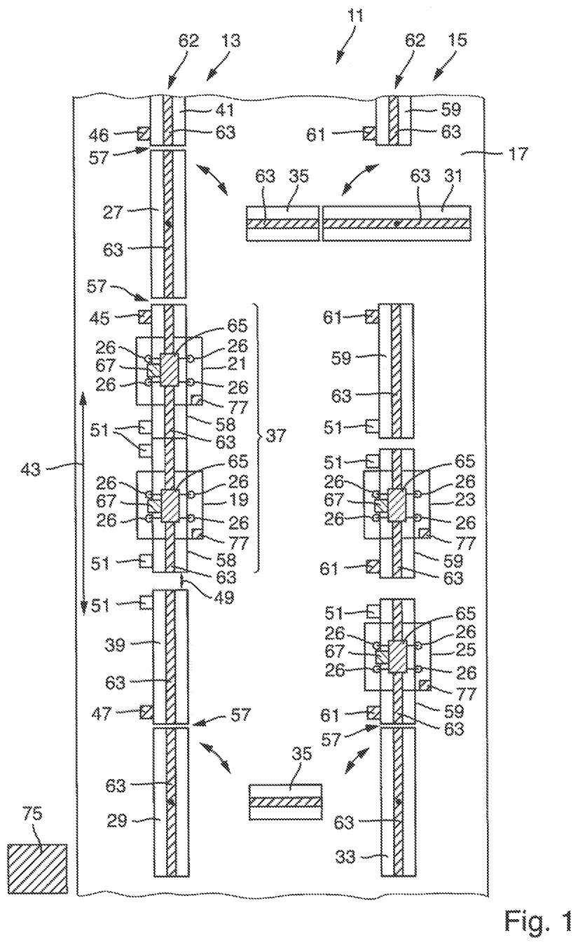

FIG. 1 shows an elevator system according to the invention;

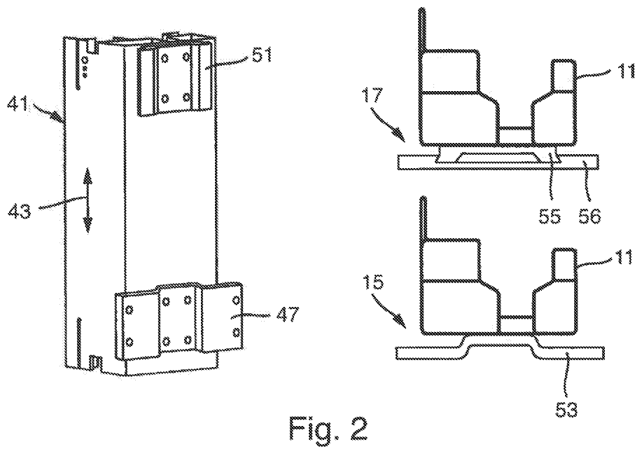

FIG. 2 shows a rail segment with a fixed bearing and a movable bearing;

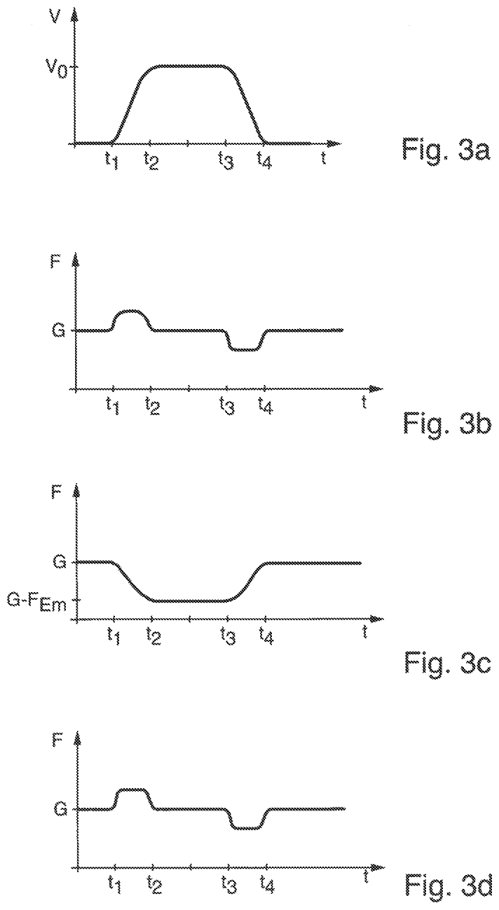

FIG. 3a shows a travel curve of an upwardly moving elevator car;

FIG. 3b shows a force profile of the upwardly moving elevator car;

FIG. 3c shows the force profile during an emergency stop of the upwardly moving elevator car;

FIG. 3d shows the profile of the maximum force of the upwardly moving elevator car;

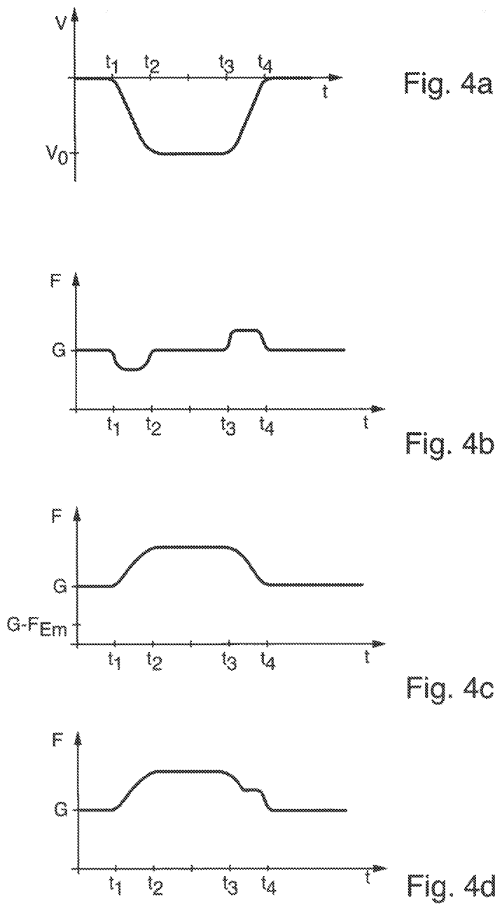

FIG. 4a shows a travel curve of a downwardly moving elevator car;

FIG. 4b shows a force profile of the downwardly moving elevator car;

FIG. 4c shows the force profile during an emergency stop of the downwardly moving elevator car;

FIG. 4d shows the profile of the maximum force of the downwardly moving elevator car;

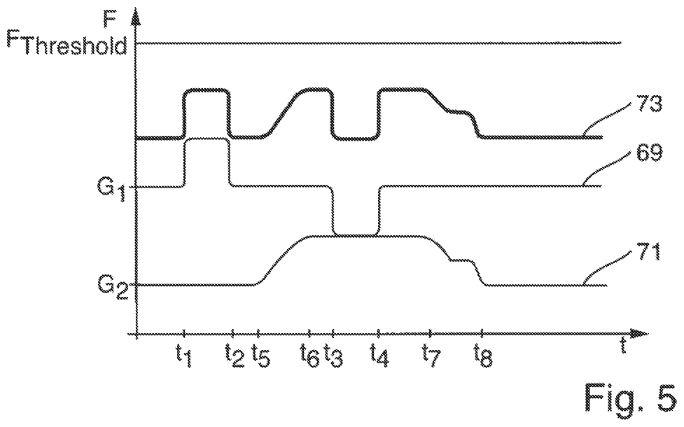

FIG. 5 shows the profile of the maximum force of two elevator cars which are in engagement with the same rail segment.

FIG. 1 is a schematic illustration of an elevator system 11 according to the invention. The elevator system 11 comprises a first rail section 13 and a second rail section 15. The rail sections 13 and 15 are arranged on a wall 17. The elevator system 11 here comprises four elevator cars 19, 21, 23 and 25 which are movable along the two rail sections 13 and 15. Each elevator car comprises guide rollers 26 which roll on the rail section during the movement of the elevator car. In the situation illustrated, the elevator cars 19 and 21 are in engagement with the first rail section 13 and the elevator cars 23 and 25 with the second rail section 15. The first rail section 13 comprises a first rotary segment 27 and a second rotary segment 29. The second rail section 15 comprises a first rotary segment 31 and a second rotary segment 33. The elevator cars 19, 21, 23, 25 can be moved between the two rail sections 13, 15 with the aid of the rotary segments 27, 29, 31, 33. For example, for this purpose, the elevator car 21 is moved onto the rotary segment 27. Subsequently, the rotary segment 27 is rotated from a vertical alignment into a horizontal alignment. At the same time, the adjacent rotary segment 31 is likewise rotated into a horizontal alignment. In the situation shown, the rotary segment 31 has already been brought into the horizontal alignment while the rotary segment 27 has still remained in the vertical alignment. The two rotary segments 27 and 31 now form a horizontal rail section together with the compensating rail element 35. The elevator car 21 is then moved along the two rotary segments and 27 and 31 which are now aligned with each other. Since the elevator car 21 is in engagement with the rotary segment 31, the two rotary segment 27 and 31 are again brought into the vertical alignment. The elevator car 21 has therefore changed from the first rail section 13 to the second rail section 15. The further elevator cars 19, 23, 25 can be transferred between the two rail sections in a corresponding manner. A detailed description of the transfer method is found in WO 2015/144781.

In addition to the first rotary segment 27 and the second rotary segment 29, the first rail section 13 comprises a plurality of rail segments 37, 39, 41 which are arranged one behind another along the direction of travel 43. The first rail segment 37 of the plurality of rail segments is arranged here adjacent to the first rotary segment 27. The first rail segment 37 is fixed here to the wall 17 via a first fixed bearing 45. The first fixed bearing 45 is arranged at that end of the first rail segment 37 which faces the first rotary segment 27. It is thereby ensured that the distance between the first rotary segment 27 and the first rail segment 37 is fixed and only minimally changes due to thermal stresses. This is required in order to ensure that the rotation of the first rotary segment 27 is not impaired by the first rail segment 37 thermally expanding. In order to ensure the rotatability of the first rotatory segment 27, there has to be a well defined gap 57 between the first rotary segment and the adjacent rail segment. Too narrow a gap 57 would lead to the first rotary segment 27 no longer being able to rotate. On the other hand, too large a gap will lead to the guide rollers 26 of the elevator cars no longer rolling in a well defined manner when traveling over the gap 57. In particular, the formation of noise or vibrations may occur when the guide rollers 26 roll over too wide a gap 57. This reduces the travel comfort and also leads to greater wear of the guide rollers 26. Consequently, the width of the gap 57 has to remain virtually constant during the operation of the elevator system 11. This is achieved in that the rail segment 37 adjacent to the first rotary segment 27 is fixed to the wall 17 via a first fixed bearing 45, wherein the first fixed bearing 45 is arranged at that end of the first rail segment 37 which faces the first rotary segment 27. The first fixed bearing 45 therefore forms a fixed point for the first rail segment 37. The distance between the first rotary segment 27 and the first fixed bearing 45 remains constant. As a result of the fact that the first fixed bearing 45 is arranged at the facing end of the first rail segment 37, an excessive thermal expansion of the rail portion lying between the first fixed bearing 45 and the closest rotary segment also does not occur. A second rail segment 39 of the plurality of rail segments is arranged adjacent to the first rail segment 37. The second rail segment is fixed here to the wall 17 via a second fixed bearing 47. The first rail segment 37 here is at a distance 49 from the second rail segment 39, and therefore the first rail segment 37 can thermally expand in the direction of the second rail segment 39. The second fixed bearing 47 is arranged at that end of the second rail segment which faces away from the first rail segment 37. Accordingly, the first rail segment 37 and the second rail segment 39 can therefore thermally expand toward each other. In addition to the fixed bearings 45 and 47 mentioned, the rail segments 37 and 39 are additionally fastened to the wall 17 by means of movable bearings 51. Movable bearings 51 fix the rail segments only perpendicularly to the direction of travel 43 and permit free displacement in the direction of travel 43. Force therefore cannot be introduced into the wall 17 parallel to the direction of travel 43 via the movable bearings 51. The first rail segment 37 is fastened to the wall 17, for example, with the aid of a total of three movable bearings 51 and the first fixed bearing 45. By contrast, the second rail segment 39 is fastened to the wall 17 only by means of one movable bearing 51 and the second fixed bearing 47. The number of required movable bearings 51 depends here on the length of the rail segment. The design and the manner of operation of the fixed bearings 45, 46 and 47 and the movable bearings 51 will be explained in more detail below with respect to FIG. 2. In particular, at least one movable bearing is arranged at that end of the rail segment which lies opposite the fixed bearing. The first rail segment 37 is thus fastened to the wall 17 by means of a movable bearing 51, wherein the movable bearing 51 is arranged at that end of the first rail segment which lies opposite the fixed bearing 45. Two further movable bearings 51 are arranged in the central region of the first rail segment 37 and fasten the first rail segment 37 to the wall 17. The second rail segment 39 is likewise fastened to the wall 17 by means of a movable bearing 51, wherein the movable bearing 51 is arranged at that end of the second rail segment 39 which lies opposite the fixed bearing 47.

The rail segments can be formed integrally or can be composed of a plurality of rail elements. The first rail segment 37 thus comprises, for example, two rail elements 58 which are arranged one behind the other along the direction of travel 43. The individual rail elements of a rail segment are fixedly connected to one another at least in the direction of travel 43. The first rail segment 37 is therefore subject as a whole to thermal expansion in the direction of travel 43.

The first rail section 13 furthermore comprises a second rotary segment 29. The second rail segment 39 is arranged adjacent to the second rotary segment 29. The first rail segment 37 and the second rail segment 39 are therefore arranged between the first rotary segment 27 and the second rotary segment 29. The second rail segment is fixed to the wall 17 via a second fixed bearing 47, wherein the second fixed bearing 47 is arranged at that end of the second rail segment which faces the second rotary segment 29. The first rail segment, which is fixed to the wall 17 by means of the first fixed bearing 45, is therefore adjacent to the first rotary segment 27. The second rail segment 39, which is fixed to the wall 17 by means of the second fixed bearing 47, is adjacent to the second rotary segment 29. The two fixed bearings 45, 47 are arranged close to the closest rotary segment, and therefore the width of the two gaps 57 between the rotary segment and adjacent rail segment remain substantially constant. By contrast, in the event of thermal expansion of the first rail segment 37 and of the second rail segment 39, the distance 49 of the two rails segments from each other changes. This leads of course also to noises and/or vibrations when the guide rollers 26 of an elevator car change from the first rail segment 37 onto the second rail segment 39. However, in contrast to rotary segments, in the case of such fixed rail segments, corresponding measures for compensating this are known. See in this respect, for example, WO 2016/113434.

In addition to the third rotary segment 31 and the fourth rotary segment 33, the second rail section 15 comprises a plurality of rail segments 59. Each rail segment 59 is fastened to the wall 17 by means of a fixed bearing 61 and a movable bearing 51. The movable bearing 51 is in each case arranged here at that end of the rail segment 59 which lies opposite the fixed bearing 61. In the case of the rail segments 59 which are arranged adjacent to the rotary segments 31 and 33, the fixed bearings 61 are each arranged at that end of the rail segment which faces the adjacent rotary segment.

The elevator system 11 furthermore comprises a linear drive 62 for driving the elevator cars 19, 21, 23 and 25. The linear drive 62 comprises a plurality of primary parts 63 which are connected to the rail segments 37, 39, 41 and 59. Further primary parts 63 are connected to the rotary segments 24, 29, 31 and 33 and to the compensating rail elements 35. Furthermore, the linear drive comprises a plurality of secondary parts 65 which are each connected to the elevator cars 19, 21, 23 and 25. If, for example, the elevator car 21 is now accelerated by means of the linear drive 62, a force acts on the elevator car 21 and the corresponding counterforce (acceleration force) acts on the first rail segment 37, with which the elevator car 21 is in engagement during the accelerating. The same applies to the other elevator cars 19, 23 and 25. In principle, the acceleration force occurring during the acceleration of the elevator car by means of the linear drive acts on that particular rail segment with which the corresponding elevator car is in engagement during the accelerating. By appropriate activation of the linear drive 62, the latter can also be used for braking the elevator cars. In this case too, a force then acts on the elevator car and the corresponding counterforce (acceleration force) acts on the rail segment, with which the elevator car is in engagement during the braking. In the case of the elevator car 21, the two forces act first of all on the primary part 63, which is connected to the rail segment 37. The force is transmitted from the primary part 63 to the rail segment 37 and is introduced from there into the wall 17 via the first fixed bearing 45. Since the acceleration force runs parallel to the direction of travel 43 and the movable bearings 51 permit free displacement parallel to the direction of travel 43, the acceleration force is transmitted exclusively via the first fixed bearing 45.

In addition, each of the elevators cars 19, 21, 23 and 25 has a braking device 67. The braking device 67 is, for example, a shoe brake in which brake shoes are brought into contact with the rail segments for the braking. The braking device 67 therefore acts on that particular rail segment with which the corresponding elevator car is in engagement when the braking device 67 is activated. In the case of the elevator car 21, this is, for example, the first rail segment 37. During braking of the elevator car 21, the acceleration force which occurs is therefore introduced into the first rail segment 37. Since the acceleration force runs parallel to the direction of travel 43 and the movable bearings 51 permit free displacement parallel to the direction of travel 43, the acceleration force which occurs during braking by the braking device 67 is therefore transmitted exclusively via the first fixed bearing 45.

Since the elevator cars 19, 21, 23 and 25 are not connected to a counterweight via a suspension rope, as in conventional elevator systems, the weight force of the elevator cars has to be introduced into the rail segments in some way or other. While an elevator car stops, for example, at a stop, the braking device 67 is activated and thus keeps the elevator car in its position. The weight force of the elevator car therefore acts via the braking device 67 of the elevator car on that particular rail segment with which the corresponding elevator car is in engagement. When the elevator car starts up, the braking device 67 is deactivated. The weight force of the elevator car is then absorbed by the linear drive 62. In a manner corresponding to the explanation with respect to the acceleration force, the weight force first of all acts on the primary part 63. The force is transmitted from the primary part 63 to the rail segment, with which the corresponding elevator car is in engagement. As a result, the weight force therefore acts in both cases (linear drive, braking device) on that particular rail segment with which the corresponding elevator car is in engagement.

FIG. 2 shows a rail segment 41 with a fixed bearing 47 and a movable bearing 51. In the right region of FIG. 2, there is a respective cross section through the rail segment 41 in the region of the fixed bearing 47 (lower illustration) and in the region of the movable bearing 51 (upper illustration). The fixed bearing 47 comprises a first holder 53 which firstly is connected fixedly to the rail segment 41 and secondly is connectable (for example screwable) fixedly to the wall 17. The movable bearing 51 comprises a second holder 55 which is fixedly connected to the rail segment 41. The second holder 55 is accommodated in a form-fitting manner by a mounting 56 in which the second holder 56 is movable only in one direction (perpendicularly to the plane of the drawing). After the installation, this direction corresponds to the direction in which the rail segment 41 can expand freely thermally, i.e. the direction of travel 43. The mounting 56 is in turn fixedly connectable to the shaft wall 17.

FIG. 3a illustrates the travel curve of an upwardly moving elevator car. The time t is illustrated on the x axis and the speed v on the y axis. At the time t<t₁, the elevator car stops at a stop, and therefore the speed is v=0. At the time t₁, the elevator car is accelerated until the travel speed v=v₀ is reached at the time t₂. This speed is maintained by the elevator car until the braking begins at the time t₃, and therefore the speed is reduced. At the time t₄, the elevator car comes again to a standstill.

It is assumed for the description below that the rail segments are provided with the primary part of the linear motor. This leads to all of the forces which the linear motor acts on the elevator car resulting in corresponding counterforces which are introduced into the rail segments. In the event that the primary parts and rail segments are fixed independently of one another to the wall by means of fixed bearings, the corresponding reasoning in each case applies.

The force curves illustrated below (FIGS. 3b, 3c, 3d, 4b, 4c, 4d) each show the profile of the forces which are introduced into the rail segments. Since the elevator car is supported on the rail segments, these are always the counter forces to the forces which act on the elevator car.

FIG. 3b shows the forces which actually occur in the case of the travel curve according to FIG. 3a and are introduced into the rail segments. The time t is illustrated on the x axis and the force F on the y axis. At the time t<t₁, the elevator car stops at a stop, and therefore the weight force G is in effect. During the acceleration phase t₁<t<t₂, an acceleration force is in effect in addition to the weight force until the elevator car has reached its travel speed. During the travel at a constant speed at the time t₂<t<t₃, only the weight force is again in effect. Frictional forces are ignored in this view. During the braking phase t₃<t<t₄, an acceleration force is in effect which is directed counter to the weight force, and therefore the force which is introduced into the rail elements is reduced in sum.

FIG. 3c shows the forces which would occur if the elevator car carries out an emergency stop at a time t. The elevator car is in the travel state here corresponding to the travel curve according to FIG. 3a. No additional forces occur at the times t<t₁ and t>t₄ since the elevator car is in any case stationary. At the time t₁<t<t₃, the elevator car moves at the constant travel speed vo. In order to brake the elevator car as rapidly as possible, a force F_{Em} (emergency) is required which in this case is directed counter to the weight force. The force G−F_{Em} would therefore act on the rail element. Since the required emergency stopping force F_{Em} depends on the current speed, a continuous transition is produced in the regions t₁<t<t₂ and t₃<t<t₄.

FIG. 3d shows the maximum force of the elevator car having the travel curve according to FIG. 3a. The maximum force at a time t is defined as the maximum of the force actually introduced into the rail segment at this time and the force introduced at this time during an emergency stop—i.e. the maximum of the curve according to FIG. 3b and FIG. 3c. In this case of an upwardly moving elevator car, the maximum is given by the curve according to FIG. 3b, and therefore FIG. 3b and FIG. 3d are identical.

FIG. 4a illustrates the travel curve of a downwardly moving elevator car. The time t is also illustrated here on the x axis and the speed v on the y axis. At the time t<t₁, the elevator car stops at a stop, and therefore the speed is v=0. At the time t₁, the elevator car is accelerated until the travel speed v=v₀ is reached at the time t₂. The speed v₀ is negative here since the elevator car is moving downward. This speed is maintained by the elevator car until the braking begins at the time t₃, and therefore the amount of the speed is reduced. At the time t₄, the elevator car has come again to a standstill.

FIG. 4b shows the forces which actually occur during the travel curve according to FIG. 4a and are introduced into the rail segments. The time t is illustrated on the x axis and the force F on the y axis. At the time t<t₁, the elevator car stops at a stop, and therefore the weight force G is in effect. During the acceleration phase t₁<t<t₂, in addition to the weight force an acceleration force is in effect until the elevator car has reached its travel speed. However, the acceleration force is directed counter to the weight force, and therefore a lower force in total is introduced into the rail elements. During the travel at a constant speed at the time t₂<t<t₃, only the weight force is again in effect. Frictional forces are ignored in this view. During the braking phase t₃<t<t₄, an acceleration force is in effect which is directed in the same direction as the weight force, and therefore the force which is introduced into the rail elements is increased in sum.

FIG. 4c shows the forces which would occur if the elevator car carries out an emergency stop at a time t. The elevator car here is in the travel state corresponding to the travel curve according to FIG. 4a. At the times t<t₁ and t>t₄, no additional forces occur since the elevator car is in any case stationary. At the time t₁<t<t₃, the elevator car moves at the constant travel speed v₀. In order to brake the elevator car as rapidly as possible, a force F_{Em} is required which in this case is directed in the same direction as the weight force. G+F_{Em} would therefore act as the force on the rail elements. Since the required emergency stopping force F_{Em} depends on the current speed, a continuous transition is produced in the regions t₁<t<t₂ and t₃<t<t₄.

FIG. 4d shows the maximum force of the elevator car having the travel curve according to FIG. 4a. The maximum force at a time t is defined as the maximum of the force actually introduced into the rail segment at this time and the force introduced at this time during an emergency stop—i.e. the maximum of the curve according to FIG. 4b and FIG. 4c.

FIG. 5 shows the profile of the maximum force of two elevator cars which are in engagement with the same rail segment. A first elevator car is fully loaded and therefore has the weight force G₁ which is higher than the weight force G₂ of a second elevator car. The first elevator car stops up to a time t=t₁ at a stop and then moves upward until it comes again to a standstill at a stop at the time t=t₄. The maximum force therefore proceeds as explained with respect to FIG. 3d. The corresponding curve is denoted by 69 in FIG. 5. A second elevator car has the weight force G₂ and begins a downward travel at the time t=t₅. At the time t₆, it has reached the travel speed and, at the time t₇, begins braking until it has come to a standstill again at the time t=t₈. The curve of the maximum force 71 of said elevator car therefore behaves in a manner corresponding to the explanation with regard to FIG. 4d. The sum of the maximum forces of the two elevator cars therefore has the profile denoted by 73. FIG. 5 clearly shows that the two elevator cars are controlled in such a manner that the sum of the maximum forces of the two elevator cars is smaller at each time than a predetermined threshold value F_{threshold}. The control system 75 designed for this purpose is illustrated in FIG. 1. If, by contrast, the first elevator car were not fully loaded, and had a weight force corresponding to the weight force of the second elevator car, there would still be sufficient clearance as far as the predetermined threshold value, and therefore a third elevator car could also move into the rail segment. If, by contrast, the threshold value F_{threshold} is lower, the control system controls the elevator cars in such a manner that, during the normal operation of the elevator system, each rail segment is always only traveled along by precisely one elevator car. As explained previously, for example, the number of elevator cars which can move simultaneously into a rail segment depends on the weight force of the elevator cars. The elevator cars 19, 21, 23 and 25 illustrated in FIG. 1 therefore have a sensor 77 which measures the loading of the elevator cars and transmits the measurement to the control system 75. The control system 75 is designed to determine the maximum forces of all of the elevator cars with the aid of the sensor signal of the sensor 77 and the travel curves (FIG. 3a, FIG. 4a) predetermined by the control system 75.

It has been explained in conjunction with FIG. 1 that the forces acting on a rail segment are introduced into the wall 17 via precisely one fixed bearing. The predetermined threshold value is therefore predetermined as being 10%, in particular 20%, lower than the maximally permissible load of said fixed bearing. The control system 75 then ensures with the aid of the above-described control method that the load of the fixed bearing is never exceeded and also a sufficient safety margin remains. It is thereby ensured that safe operation of the elevator system is made possible while at the same time the rail sections are used efficiently by the elevator cars being able to travel closely to one another.

### LIST OF REFERENCE SIGNS

11 elevator system

13 first rail section

15 second rail section

17 wall

19 elevator car

21 elevator car

23 elevator car

25 elevator car

26 guide rollers

27 first rotary segment

29 second rotary segment

31 third rotary segment

33 fourth rotary segment

35 compensating rail element

37 first rail segment

39 second rail segment

41 rail segment

43 direction of travel

45 first fixed bearing

47 second fixed bearing

49 distance

51 movable bearing

53 first holder

55 second holder

56 mounting

57 gap

58 rail element

59 rail segment

61 fixed bearing

62 linear drive

63 primary parts

65 secondary parts

67 braking device

69 maximum force curve of first elevator car

71 maximum force curve of second elevator car

73 sum of the maximum force curves of the two elevator cars

75 control system

77 sensor

1.-15. (canceled)

16. An elevator system comprising:
a first elevator car;
a second elevator car; and
a rail section disposed on a wall, wherein the first and second elevator cars are movable along the rail section, wherein the rail section comprises:
rail segments that are disposed consecutively in a direction of travel of the first and second elevator cars, wherein a first rail segment of the rail segments is fixed to the wall via a first fixed bearing, and
a rotary segment adjacent to the first rail segment, wherein the first fixed bearing is disposed at an end of the first rail segment that faces the first rotary segment.

17. The elevator system of claim 16 wherein a second rail segment of the rail segments is adjacent to the first rail segment, the second rail segment being fixed to the wall via a second fixed bearing, wherein the first rail segment is spaced apart from the second rail segment to permit the first rail segment to thermally expand towards the second rail segment.

18. The elevator system of claim 17 wherein the second fixed bearing is disposed at an end of the second rail segment that faces away from the first rail segment so as to permit the first rail segment and the second rail segment to thermally expand toward each other.

19. The elevator system of claim 18 wherein the rail section comprises a second rotary segment, wherein the second rail segment is adjacent to the second rotary segment, wherein the first rail segment and the second rail segment are disposed between the first rotary segment and the second rotary segment, wherein the second fixed bearing is disposed at an end of the second rail segment that faces the second rotary segment.

20. The elevator system of claim 17 wherein a plurality of rail segments are disposed between the first rail segment and the second rail segment.

21. The elevator system of claim 16 wherein at least one of the first rail segment or the second rail segment comprises a plurality of rail elements that are disposed consecutively along the direction of travel.

22. The elevator system of claim 16 wherein the first and second elevator cars each comprise a braking device that acts on the rail segment with which the respective elevator car is engaged when the braking device is activated, wherein an acceleration force that occurs during braking of the respective elevator car is introduced into the rail segment with which the respective elevator car is engaged.

23. The elevator system of claim 16 comprising a linear drive for driving the first and second elevator cars, the linear drive comprising:
primary parts that are connected to the rail segments, and
secondary parts that are connected to the first and second elevator cars, wherein an acceleration force that occurs during acceleration or braking of the first or second elevator car by way of the linear drive acts on the respective rail segment with which the first or second elevator car is engaged during the acceleration or the braking.

24. The elevator system of claim 23 wherein the first and second elevator cars each comprise a braking device that acts on the rail segment with which the respective elevator car is engaged when the braking device is activated, wherein an acceleration force that occurs during braking of the respective elevator car is introduced into the rail segment with which the respective elevator car is engaged, wherein the first and second elevator cars are engaged with the rail segments such that a weight force of each of the first and second elevator cars acts via the linear drive or via the braking device on the respective rail segment with which the first or second elevator car is engaged.

25. An elevator system comprising:
a first elevator car;
a second elevator car;
a rail section along which the first and second elevator cars are movable, wherein the rail section comprises rail segments that are disposed consecutively along a direction of travel of the first and second elevator cars; and
a control system for controlling movement of the first and second elevator cars, the control system configured to control the first and second elevator cars such that a sum of forces attributable to the first and second elevator cars, when the first and second elevator cars are simultaneously engaged with one of the rail segments and when the sum of forces acts on the one of the rail segments, is smaller than a predetermined threshold value.

26. The elevator system of claim 25 comprising a sensor for determining the loading of the first and second elevator cars, wherein the control system is configured to determine maximum forces of the first and second elevator cars via a sensor signal of the sensor.

27. The elevator system of claim 25 wherein the predetermined threshold value is 2% less than a maximal permitted load of a fixed bearing of a rail element.

28. The elevator system of claim 25 wherein during normal operation of the elevator system the control system is configured to control the first and second elevator cars such that only one of the first or second elevator cars travels on each of the rail segments at a time.

29. The elevator system of claim 28 wherein a maximum force attributable to the first or second elevator car and exerted on one of the rail segments is less than the predetermined threshold value.
